(19) United States
(12) Patent Application Publication
(10) Pub. No.: US 2006/0140849 A1
(43) Pub. Date: Jun. 29, 2006

(54) Catalyst for the catalytic oxidation of hydrogen chloride

(76) Inventors: Christian Kuhrs, Heidelberg (DE); Christian Walsdorff, Ludwigshafen (DE); Martin Fiene, Niederkirchen (DE); Eckhard Stroefer, Mannheim (DE); Klaus Harth, Altleiningen (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/529,208

(22) PCT Filed: Sep. 25, 2003
(86) PCT No.: PCT/EP03/10657

§ 371 Date: Dec. 16, 2005

(30) Foreign Application Priority Data
Sep. 26, 2002 (DE) 102 44 996.1

(51) Int. Cl. C01B 7/00

(52) U.S. Cl. 423/502

(57) ABSTRACT

The invention relates to a catalyst for the catalytic oxidation of hydrogen chloride, comprising on a support a) from 0.001 to 30% by weight of gold, b) from 0 to 3% by weight of one or more alkaline earth metals, c) from 0 to 3% by weight of one or more alkali metals, d) from 0 to 10% by weight of one or more rare earth metals, e) from 0 to 10% by weight of one or more further metals selected from the group consisting of ruthenium, palladium, platinum, osmium, iridium, silver, copper and rhenium, in each case based on the total weight of the catalyst.

The invention relates to a catalyst for the catalytic oxidation of hydrogen chloride to chlorine by means of oxygen and to a process for the catalytic oxidation of hydrogen chloride.

In the process developed by Deacon in 1868 for the catalytic oxidation of hydrogen chloride, hydrogen chloride is oxidized by means of oxygen in an exothermic equilibrium reaction to form chlorine. The conversion of hydrogen chloride into chloride enables chlorine production to be decoupled from the production of sodium hydroxide by chloralkali electrolysis. Such decoupling is attractive since the world demand for chlorine is growing more quickly than the demand for sodium hydroxide. In addition, hydrogen chloride is obtained in large quantities as coproduct, for example in phosgenation reactions, for instance in isocyanate production.

EP-A 0 743 277 discloses a process for preparing chlorine by catalytic oxidation of hydrogen chloride, in which a supported ruthenium-containing catalyst is used. Here, ruthenium is applied in the form of ruthenium chloride, ruthenium oxychlorides, chlororuthenate complexes, ruthenium hydroxide, ruthenium-amine complexes or in the form of further ruthenium complexes to the support. The catalyst may further comprise palladium, copper, chromium, vanadium, manganese, alkali metals, alkaline earth metals and rare earth metals as additional metals.

According to GB 1,046,313, ruthenium(III) chloride on silicon dioxide is used as catalyst in a process for the catalytic oxidation of hydrogen chloride.

A disadvantage of the ruthenium-containing catalysts is the high volatility of the ruthenium compounds. Furthermore, it is desirable to carry out the exothermic hydrogen chloride oxidation at low temperatures because the position of the equilibrium is then more favorable. Catalysts having a high activity at low temperatures are required for this purpose.

It is an object of the present invention to provide an improved process for the catalytic oxidation of hydrogen chloride.

We have found that this object is achieved by a catalyst for the catalytic oxidation of hydrogen chloride, comprising on a support
a) from 0.001 to 30% by weight of gold,
b) from 0 to 3% by weight of one or more alkaline earth metals,
c) from 0 to 3% by weight of one or more alkali metals,
d) from 0 to 10% by weight of one or more rare earth metals,
e) from 0 to 10% by weight of one or more further metals selected from the group consisting of ruthenium, palladium, platinum, osmium, iridium, silver, copper and rhenium,
   in each case based on the total weight of the catalyst.

It has been found that the gold-containing supported catalysts of the present invention display a significantly higher activity in the oxidation of hydrogen chloride than do the ruthenium-containing catalysts of the prior art, in particular at temperatures of ≦250° C.

The catalysts of the present invention comprise gold on a support. Suitable supports are silicon dioxide, graphite, titanium dioxide preferably having a rutile or anatase structure, zirconium dioxide, aluminum oxide or mixtures thereof, with preference being given to titanium dioxide, zirconium dioxide, aluminum oxide or mixtures thereof.

The catalysts of the present invention can be obtained by application of gold in the form of the aqueous solution of a soluble gold compound and subsequent drying or drying and calcination. Gold is preferably applied to the support as an aqueous solution of AuCl₃ or HAuCl₄.

In general, the catalysts of the present invention contain from 0.001 to 30% by weight, preferably from 0.01 to 10% by weight, particularly preferably from 0.1 to 5% by weight, of gold.

The catalysts of the present invention can further comprise compounds of other noble metals selected from among ruthenium, palladium, platinum, osmium, iridium, silver, copper and rhenium. In addition, the catalysts of the present invention can be doped with further metals. Promoters suitable for doping are alkali metals such as lithium, sodium, potassium, rubidium and cesium, preferably lithium, sodium and potassium, particularly preferably potassium, alkaline earth metals such as magnesium, calcium, strontium and barium, preferably magnesium and calcium, particularly preferably magnesium, rare earth metals such as scandium, yttrium, lanthanum, cerium, praseodymium and neodymium, preferably scandium, yttrium, lanthanum and cerium, particularly preferably lanthanum and cerium, or mixtures thereof.

The catalysts of the present invention are obtained by impregnation of the support material with aqueous solutions of salts of the metals. The metals other than gold are usually applied to the support as aqueous solutions of their chlorides, oxychlorides or oxides. The shaping of the catalyst can be carried out after or preferably before impregnation of the support material.

The shaped catalyst bodies can have any shape; preference is given to pellets, rings, cylinders, stars, wagon wheels or spheres, and particular preference is given to rings, cylinders or star extrudates. The specific surface area of the support substance before deposition of the metal salt is preferably in the range from 20 to 400 m²/g, particularly preferably from 75 to 250 m²/g. The pore volume is usually in the range from 0.15 to 0.75 cm³/g.

The shaped bodies can subsequently be dried and if appropriate calcined at from 100 to 400° C., preferably from 100 to 300° C., for example under a nitrogen, argon or air atmosphere. Preference is given to firstly drying the shaped bodies at from 100 to 150° C. and subsequently calcining them at from 200 to 400° C. The catalyst is subsequently reduced if necessary.

The present invention also provides a process for the catalytic oxidation of hydrogen chloride to chlorine by means of oxygen over the catalyst of the present invention.

For this purpose, a stream of hydrogen chloride and an oxygen-containing stream are fed into an oxidation zone and hydrogen chloride is partly oxidized to chlorine in the presence of a catalyst to give a product gas stream comprising chlorine, unreacted oxygen, unreacted hydrogen chloride and water vapor.

Usual reaction temperatures are from 150 to 500° C., and usual reaction pressures are from 1 to 25 bar. Since the reaction is an equilibrium reaction, it is advantageous to work at the lowest possible temperatures at which the catalyst still has a satisfactory activity. The reaction temperature is preferably ≦350° C., particularly preferably from 200 to 250° C.

Furthermore, it is advantageous to use oxygen in superstoichiometric amounts. It is usual, for example, to use a two- to four-fold excess of oxygen. Since no decreases in selectivity are to be feared, it can be economically advantageous to work at relatively high pressures and accordingly longer residence times than at atmospheric pressure.

Usual reaction apparatuses in which the catalytic hydrogen chloride oxidation of the present invention is carried out are fixed-bed or fluidized-bed reactors. The oxidation of hydrogen chloride can be carried out in one or more stages.

The catalytic oxidation of hydrogen chloride can be carried out adiabatically or preferably isothermally or approximately isothermally, batchwise or preferably continuously as a fluidized-bed or fixed-bed process, preferably as a fixed-bed process, particularly preferably in shell-and-tube reactors, over heterogeneous catalysts at reactor temperatures of from 150 to 500° C., preferably from 150 to 250° C., particularly preferably from 200 to 250° C., and a pressure of from 1 to 25 bar, preferably from 1.2 to 20 bar, particularly preferably from 1.5 to 17 bar and in particular from 2.0 to 15 bar.

In an isothermal or approximately isothermal process, it is also possible for a plurality of reactors, for example from 2 to 10, preferably from 2 to 6, particularly preferably from 2 to 5 and in particular from 2 to 3 reactors, connected in series with additional intermediate cooling to be used. The oxygen can either all be introduced together with the hydrogen chloride upstream of the first reactor or can be added at points distributed over the various reactors. This series arrangement of individual reactors can also be combined in one apparatus.

In a preferred embodiment, a structured catalyst bed in which the catalyst activity increases in the flow direction is used. Such structuring of the catalyst bed can be achieved by differing impregnation of the catalyst supports with active composition or by differing dilution of the catalyst with an inert material. As inert material, it is possible to use, for example, rings, cylinders or spheres made of titanium dioxide, zirconium dioxide or mixtures thereof, aluminum oxide, steatite, ceramic, glass, graphite or stainless steel. In the case of the preferred use of shaped catalyst bodies, the inert material should preferably have similar external dimensions.

The conversion of hydrogen chloride in a single pass can be limited to from 15 to 90%, preferably from 40 to 85%. Unreacted hydrogen chloride can be separated off and partly or wholly returned to the catalytic hydrogen chloride oxidation. The volume ratio of hydrogen chloride to oxygen at the inlet to the reactor is generally from 1:1 to 20:1, preferably from 1.5:1 to 8:1, particularly preferably from 1.5:1 to 5:1.

The chlorine formed can subsequently be separated off in a customary manner from the product gas stream obtained in the catalytic oxidation of hydrogen chloride. It is usually separated off in a plurality of stages, namely separation of unreacted hydrogen chloride from the product gas stream of the catalytic oxidation of hydrogen chloride and, if desired, recirculation of the hydrogen chloride, drying of the resulting residual gas stream consisting essentially of chlorine and oxygen and separation of chlorine from the dried stream.

1. A process for the catalytic oxidation of hydrogen chloride to chlorine by means of oxygen over a catalyst comprising on a support
a) from 0.001 to 30% by weight of gold,
b) from 0 to 3% by weight of one or more alkaline earth metals,
c) from 0 to 3% by weight of one or more alkali metals,
d) from 0 to 10% by weight of one or more rare earth metals,
e) from 0 to 10% by weight of one or more further metals selected from the group consisting of ruthenium, palladium, platinum, osmium, iridium, silver, copper and rhenium,
in each case based on the total weight of the catalyst, wherein the carrier is selected from the group consisting of titanium dioxide, zirconium dioxide, aluminum oxide and mixtures thereof, and wherein gold is applied to the support as an aqueous solution of a gold compound.

2. The process as claimed in claim 1, wherein gold is applied to the support as an aqueous solution of AuCl₃ or HAuCl₄.

3. The process as claimed in claim 1, wherein the metals other than gold are applied to the support as aqueous solutions of their chlorides, oxychlorides and oxides.

4. The process as claimed in claim 1, wherein the reaction temperature is ≦300° C.
